(19) United States
(12) Patent Application Publication
(10) Pub. No.: US 2016/0232148 A1
(43) Pub. Date: Aug. 11, 2016

(54) Dynamic Location-Based Autopopulation

(71) Applicant: PAYPAL, INC., San Jose, CA (US)

(72) Inventor: Vitalii Stepanenko, Kyiv (UA)

(21) Appl. No.: 15/099,249

(22) Filed: Apr. 14, 2016

Related U.S. Application Data
(63) Continuation of application No. 13/711,365, filed on Dec. 11, 2012.

(51) Int. Cl. G06F 17/24; H04W 4/02

(52) U.S. Cl. CPC G06F 17/243; H04W 4/02

(57) ABSTRACT

Methods, systems, and computer program products for providing dynamic location-based auto-population are disclosed. A computer-implemented method may include providing a user interface for an internet application in a web browser on a device allowing the device to participate in an online transaction involving a server machine of another party via the internet, determining a data field of the internet application to auto-populate with an address associated with dynamic location data from the device, retrieving the dynamic location data from the device, determining the address associated with the dynamic location data, automatically updating the user interface by auto-populating the internet application data field with the determined address associated with the dynamic location data, and providing a version of the address auto-populated in the internet application data field to the server machine of the other party via the internet as part of completing the online transaction.

### CROSS-REFERENCE TO RELATED APPLICATION

This application is a continuation of U.S. patent application Ser. No. 13/711,365, filed Dec. 11, 2002, which is also hereby incorporated by reference in its entirety.

### BACKGROUND

1. Field of the Invention

The present invention generally relates to auto-filling and more particularly to address auto-filling.

2. Related Art

Online and mobile purchases provide many advantages over in-person or purchases at physical stores, such as the ability to shop at the convenience of a consumer's home, work, or anywhere, and at any time of day. Advantages also include a wider range of items and merchants to choose from, as the consumer is able to browse online merchants located virtually anywhere in the world. The consumer typically has to provide certain information to complete the transaction and make the purchase. The purchased items can then be picked up locally or shipped to the consumer. For the latter, the consumer would be required to provide a shipping address.

Recently, purchases through a mobile device have become more and more popular through mobile apps on a user mobile device. However, although convenient due to their small sizes, mobile devices also have smaller screens and data inputs, such as keypad or virtual keyboard. This may result in errors or at least inconvenience to the user to manually enter a shipping address.

Therefore, a need exists for a user to more easily enter a shipping address on a mobile device.

### BRIEF DESCRIPTION OF THE FIGURES

FIG. 1 is a flowchart showing a process for automatically filling in a shipping address according to one embodiment;

FIG. 2 is block diagram of a networked system suitable for implementing the process described herein according to an embodiment; and

FIG. 3 is a block diagram of a computer system suitable for implementing one or more components in FIG. 2 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to various embodiments, a service provider determines an address of a user device based on a detected location of the user device and automatically fills in a shipping address on the user device for a purchase made through the user device. As such, the user does not have to manually enter a shipping address using the user device.

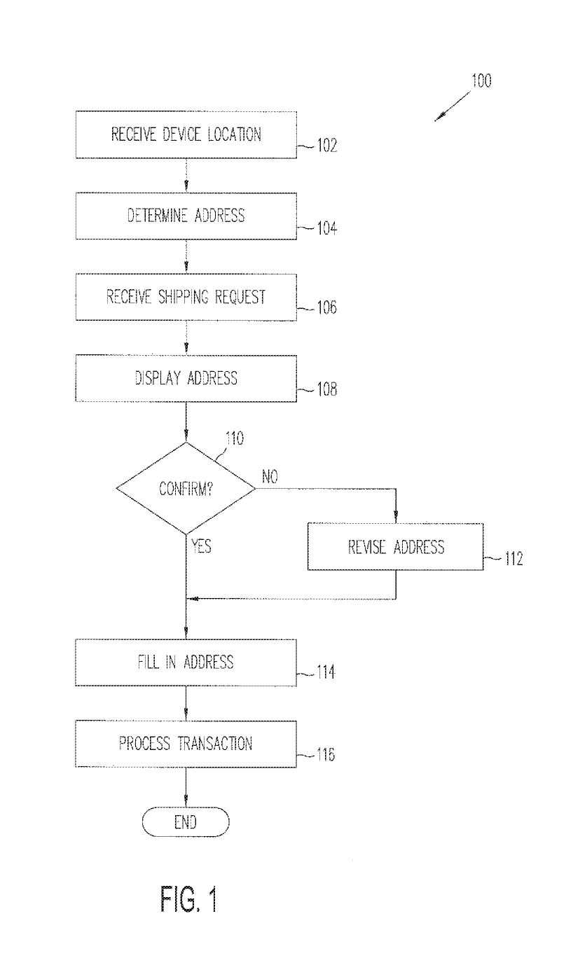

FIG. 1 is a flowchart showing a process 100 for automatically filling in a shipping address according to one embodiment. At step 102, a service provider receives location information for a user device. The service provider may be a payment provider, such as PayPal, Inc. of San Jose, Calif., an online marketplace, such as eBay, Inc., an online retailer, or any entity that provides online services to a user or consumer. The user device, in one embodiment, is a smart phone. In other embodiments, the user device may be a computing tablet, a PC, a laptop, or any mobile computing device capable of electronic communication.

Location from the user device can be received or determined in various ways. For example, the location of a phone or other device may be determined using one or more of the following alone or in combination: GPS, assisted GPS, synthetic GPS, cell ID, Wi-Fi, inertial sensors, barometer, ultrasonic, Bluetooth beacons, and terrestrial transmitters. Note that this list is not exhaustive and other means of obtaining location information may also be suitable.

GPS

Global Positioning System is a now a common way to determine a device location. GPS uses a constellation of satellites that send location and timing data from space directly to the user's phone. Signals received from three satellites enables a location to be determined. With signals from four satellites, elevation can also be determined. Other countries also have their own satellite systems to enable location determination. However, GPS or location systems using satellites require the user device to be able to receive the satellite signals and accuracy or resolution may not be as fine as other systems below.

Assisted GPS

Assisted GPS or A-GPS enhances the performance of standard GPS in devices connected to the cellular network. A-GPS improves the location performance of cell phones (and other connected devices) in two ways: 1) By helping obtain a faster “time to first fix” (TTFF). A-GPS acquires and stores information about the location of satellites via the cellular network (see almanac) so the information does not need to be downloaded via satellite; and 2) By helping position a phone or mobile device when GPS signals are weak or not available. GPS satellite signals may be blocked, at least partially, by buildings and do not penetrate building interiors well. A-GPS uses proximity to cellular towers to calculate position when GPS signals are not available.

Synthetic GPS

The form of assisted GPS described above still requires an available data network and the time to transmit the satellite information. Synthetic GPS uses computing power to forecast satellites' locations days or weeks in advance. This function began in data centers but increasingly can be carried out on phones themselves, which enables a faster determination of location.

Cell ID

While the above requires reception of satellite signals, Cell ID uses terrestrial base stations to determination location. Carriers can determine which cell a customer is using, and how far they are from the neighboring cells, with a technology called Cell ID. By knowing which sector of which base station a given phone is using, and using a database of base-station identification numbers and locations, the carriers can associate the phone's location with that of the cell tower. This system tends to be more precise in urban areas with many small cells than in rural areas, where cells may cover an area several kilometers in diameter.

Wi-Fi

Wi-Fi can determine location similar to Cell ID, but with greater precision because Wi-Fi access points cover a smaller area. There are actually two ways Wi-Fi can be used to determine location. The most common, called RSSI (received signal strength indication), takes the signals your phone detects from nearby access points and refers to a database of Wi-Fi networks. The database identifies where each unique access point is located. Using signal strength to determine distance, RSSI determines where a device is in relation to those known access points. Another form of Wi-Fi location, wireless fingerprinting, uses profiles of given places that are based on the pattern of Wi-Fi signals found there. This technique may be suitable for places or locations a user's device visits frequently. The fingerprint may be created and stored the first time a device is at the location, or a service provider may send someone out to stand in certain spots in a building and record a fingerprint for each one. Fingerprinting may be able to identify a device location to within just a few meters.

Inertial Sensors

Most smart phones have three inertial sensors: a compass (or magnetometer) to determine direction, an accelerometer to report how fast the phone is moving in that direction, and a gyroscope to sense turning motions. Together, these sensors can determine device location with no outside inputs, but only for a limited time, using an earlier location of the device, such as determined through GPS or another means. For example, a device location may be determined through GPS, but then the GPS signals are lost, such as when the device goes through a tunnel. Based on inertial sensor data, a subsequent location can be determined based on how fast the device is traveling or accelerating and direction (e.g., straight or turns).

Barometer

Barometers allow a height or elevation location to be determined, such as what floor a device is located on. For example, GPS and other location determining methods can typically determine location on a flat map, but not height. While GPS can determine elevation with a fourth satellite signal, such signals may have reception issues, especially in tall buildings or indoors. One way to determine elevation is a barometer, which uses the principle that air gets thinner at higher elevations. Some smart phones have chips that can detect barometric pressure, but this technique is not usually suited for use by itself. To use it, the phone needs to obtain local weather data for a baseline figure on barometric pressure, and conditions inside a building such as heating or air-conditioning flows can affect the sensor's accuracy. A barometer works best with mobile devices that have been carefully calibrated for a specific building, so it might work better in a user's office.

Ultrasonic

Short-range wireless systems or NFC systems, such as RFID (radio-frequency identification) can be used to verify that consumers have walked into a store. Ultrasonic tones can be broadcast within a store or location, such as just inside the doors of a shop. The consumer phone may be able to receive the tone through its microphone and communicate, such as through an app, to a service provider or merchant that the consumer has entered the location. As such, the service provider can determine the location of the user using the location of the store.

Bluetooth Beacons

Very precise location can be achieved in a specific area, such as inside a retail store, using beacons that send out signals via Bluetooth. The beacons, smaller than a cellphone, may be placed every few meters and can communicate with Bluetooth enabled user devices. Using a technique similar to Wi-Fi fingerprinting, the venue owner can use signals from this network of beacons or transmitters to identify locations within the space. Depending on the density of the beacons, very precise locations can be determined.

Terrestrial Transmitters

Terrestrial transmitters may be mounted on buildings and cell towers and broadcast signals similar to GPS. Because they are stationary and provide a much stronger signal to receivers than satellites do from space, user or device locations can be determined much more reliably and with greater accuracy.

Based on the device location from step 102, the system or service provider may determine an address, at step 104, of the current device location. The address, in one embodiment, includes a street number, a street name, a city, a state, a zip code or other postal code, and a country. If an exact address cannot be determined, a “closest” address will be determined, such as a street number in the middle of a range for the location and street name. Other resources may be used to determine the address from the location, such as known buildings (e.g., hotels, motels, apartment buildings, condos, etc.) or houses in that location. For example, the system or service provider may have a list of previously used addresses associated with a location or with the user. Using this information, the service provider may determine a specific address from the location through a database search. Publicly available addresses, such as through the Internet, may also be used for a location.

Next, at step 106, a request for a shipping address is received. For example, the user may be in various stages of a checkout or payment process with the service provider or an online merchant, using the user's mobile device. For example, the user may have items placed in a cart and is being asked for a shipping address for the items to be shipped to. The request for a shipping address may be received or determined by the service provider. The request may also be received in other ways, such as directly from the user by the user selecting a button or link that communicates the request to the service provider. The button or link may indicate that the user wants the shipping address to be auto-filled or that the user wants to start a checkout process.

At step 108, the service provider displays the address of the user device to the user on the user device. The address may be filled into the shipping address fields or simply be displayed as a message. For example, the user may see the address on a display of the user device or may hear the address through a speaker on the device. The address may include a street number, street name, city, state, zip code, and country or a combination thereof. The address may also include a name associated with address, such as “Hotel X” or “The Y Building.”

After the address is displayed, the user determines, at step 110, whether the address is correct and complete as the intended shipping address. For example, the street number may be off slightly or the street name may be a nearby street, but not the intended street, due to accuracy of the device location determination. Also, the address may not be complete, such as if the user wants the purchase to be shipped to an office suite or apartment number. Without elevation determination to determine a floor, the address may not include a floor for shipping, even though the street address and number is correct. With accurate elevation determination, the service provider may be able to obtain a suite number or apartment number, such as from a user identification and a database that shows the user has shipped previously to the same street name and address associated with a suite or apartment number. A suite or apartment number may also be determined through a floor plan of the building. However, there may be situations where even with accurate elevation determination, a floor and/or suite/apartment number is missing or inaccurate.

If, at step 110, the user determines the address is incomplete or in error, the user may revise the address at step 112. For example, the user may manually select a field for revision, such as a street number. The user may also clarify an address, such as by adding a suite or apartment number to a correct street address.

The shipping address, if not already in a shipping address field for the merchant, may be filled in at step 114. However, if the user revised the shipping address in the shipping address field used by the merchant to ship the purchase, this step may be skipped. Note that one or more steps described herein may be omitted, combined, and/or performed in a different sequence as desired.

Returning to step 110, if the determined address is displayed correctly, the user may confirm, such as by selecting a desired button, link, or box to indicate to the service provider that the shipping address (corresponding to the user's location) is correct. In this case, the system may automatically fill in, at step 114, a shipping address field with the displayed address.

The transaction can then be processed at step 116 and completed. For example, the merchant may receive a confirmation that payment has been approved and to send the purchased item(s) to the shipping address from step 114.

Thus, the user or consumer may complete a transaction with less friction by having a service provider automatically determine and provide a shipping address based on the user's current location, thereby eliminating the need for the user to enter a shipping address. This can be especially time-saving if the user is at a location unfamiliar to the user, such as at a hotel or visiting office.

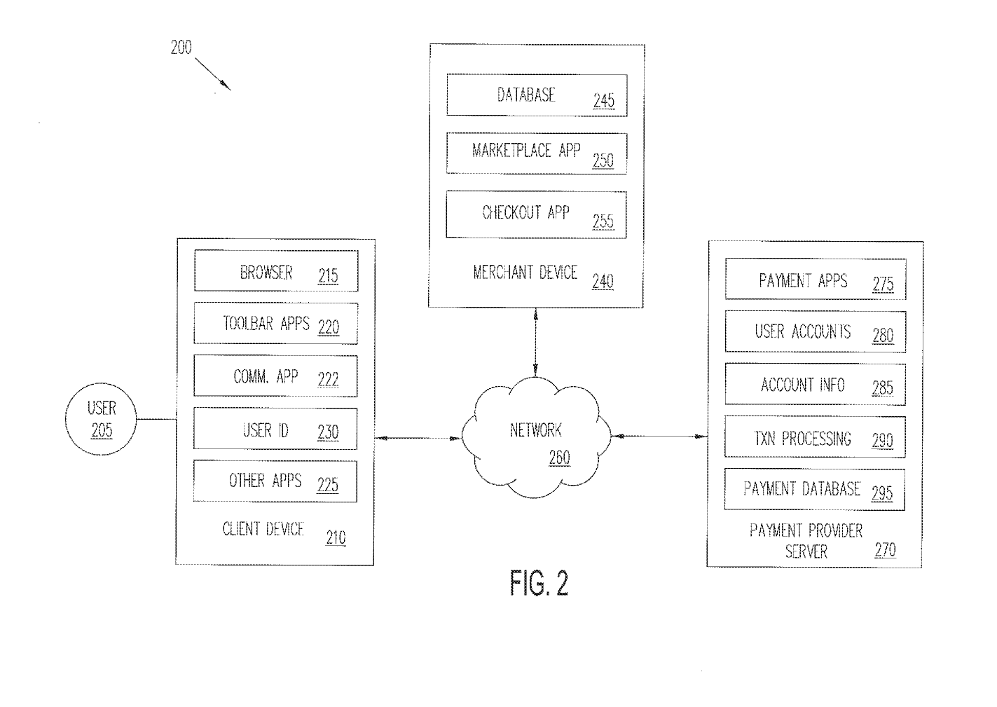

FIG. 2 is a block diagram of a networked system 200 configured to handle a location-based transaction, such as described above, in accordance with an embodiment of the invention. System 200 includes a user device 210, a merchant server 240, and a payment provider server 270 in communication over a network 260. Payment provider server 270 may be maintained by a payment provider, such as PayPal, Inc. of San Jose, Calif. A user 205, such as a sender or consumer, utilizes user device 210 to perform a transaction using payment provider server 270. Note that transaction, as used herein, refers to any suitable action performed using the user device, including payments, transfer of information, display of information, etc. that may require a user shipping address. Although only one merchant server is shown, a plurality of merchant servers may be utilized if the user is making purchases from multiple merchants for shipping to a single location.

User device 210, merchant server 240, and payment provider server 270 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 200, and/or accessible over network 260.

Network 260 may be implemented as a single network or a combination of multiple networks. For example, in various embodiments, network 260 may include the Internet or one or more intranets, landline networks, wireless networks, and/or other appropriate types of networks.

User device 210 may be implemented using any appropriate hardware and software configured for wired and/or wireless communication over network 260. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™.

User device 210 may include one or more browser applications 215 which may be used, for example, to provide a convenient interface to permit user 205 to browse information available over network 260. For example, in one embodiment, browser application 215 may be implemented as a web browser configured to view information available over the Internet, such as merchant site for purchasing. User device 210 may also include one or more toolbar applications 220 which may be used, for example, to provide client-side processing for performing desired tasks in response to operations selected by user 205, such as purchases from a selected merchant site or app. In one embodiment, toolbar application 220 may display a user interface in connection with browser application 215 as further described herein.

User device 210 may further include other applications 225 as may be desired in particular embodiments to provide desired features to user device 210. For example, other applications 225 may include security applications for implementing client-side security features, programmatic client applications for interfacing with appropriate application programming interfaces (APIs) over network 260, or other types of applications. Applications 225 may also include email, texting, voice and IM applications that allow user 205 to send and receive emails, calls, and texts through network 260, as well as applications that enable the user to communicate, transfer information, and make payments as discussed above. User device 210 includes one or more user identifiers 230 which may be implemented, for example, as operating system registry entries, cookies associated with browser application 215, identifiers associated with hardware of user device 210, or other appropriate identifiers, such as used for payment/user/device authentication. In one embodiment, user identifier 230 may be used by a payment service provider to associate user 205 with a particular account maintained by the payment provider as further described herein. A communications application 222, with associated interfaces, enables user device 210 to communicate within system 200.

Merchant server 240 may be maintained, for example, by a merchant or seller offering various products and/or services in exchange for payment to be received over network 260. Merchant server 240 may be used for POS or online purchases and transactions. Generally, merchant server 240 may be maintained by anyone or any entity that receives money, which includes charities as well as retailers and restaurants. Merchant server 240 includes a database 245 identifying available products and/or services (e.g., collectively referred to as items) which may be made available for viewing and purchase by user 205. Accordingly, merchant server 240 also includes a marketplace application 250 which may be configured to serve information over network 260 to browser 215 of user device 210. In one embodiment, user 205 may interact with marketplace application 250 through browser applications over network 260 in order to view various products, food items, or services identified in database 245.

Merchant server 240 also includes a checkout application 255 which may be configured to facilitate the purchase by user 205 of goods or services identified by marketplace application 250. Checkout application 255 may be configured to accept payment information from or on behalf of user 205 through payment service provider server 270 over network 260. For example, checkout application 255 may receive and process a payment confirmation from payment service provider server 270, as well as transmit transaction information to the payment provider and receive information from the payment provider (e.g., a transaction ID), including processing a shipment of purchased item(s) to the user.

Payment provider server 270 may be maintained, for example, by an online payment service provider which may provide payment between user 205 and the operator of merchant server 240. In this regard, payment provider server 270 includes one or more payment applications 275 which may be configured to interact with user device 210 and/or merchant server 240 over network 260 to facilitate the purchase of goods or services, communicate/display information, and send payments by user 205 of user device 210 and as discussed above.

Payment provider server 270 also maintains a plurality of user accounts 280, each of which may include account information 285 associated with individual users, including previously used shipping addresses. For example, account information 285 may include private financial information of users of devices such as account numbers, passwords, device identifiers, user names, phone numbers, credit card information, bank information, or other financial information which may be used to facilitate online transactions by user 205. Account information may also include user purchase history, as well as shipping history discussed herein. Advantageously, payment application 275 may be configured to interact with merchant server 240 on behalf of user 205 during a transaction with checkout application 255 to track and manage purchases made by users and which funding sources are used, as well as incentives for a user.

A transaction processing application 290, which may be part of payment application 275 or separate, may be configured to receive information from a user device and/or merchant server 240 for processing and storage in a payment database 295. Transaction processing application 290 may include one or more applications to process information from user 205 for processing an order and payment for shipment to a user location as described herein. Payment application 275 may be further configured to determine the existence of and to manage accounts for user 205, as well as create new accounts if necessary, such as the setup, management, and use of payment accounts as discussed herein.

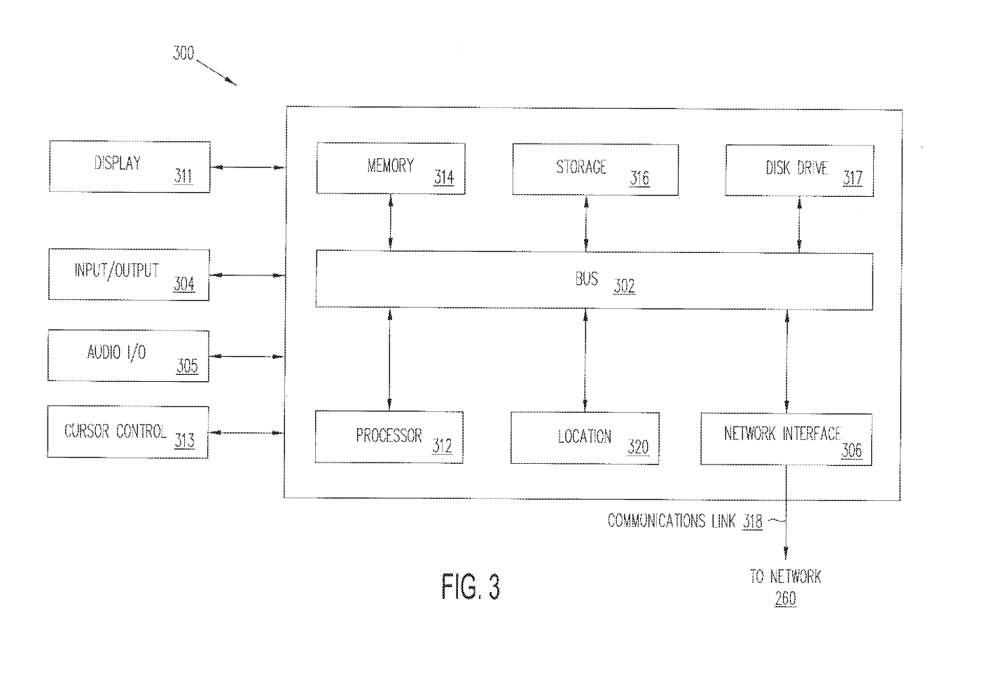

FIG. 3 is a block diagram of a computer system 300 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 300 in a manner as follows.

Computer system 300 includes a bus 302 or other communication mechanism for communicating information data, signals, and information between various components of computer system 300. Components include an input/output (I/O) component 304 that processes a user action, such as selecting keys from a keypad/keyboard, selecting one or more buttons or links, etc., and sends a corresponding signal to bus 302. I/O component 304 may also include an output component, such as a display 311 and a cursor control 313 (such as a keyboard, keypad, mouse, etc.). An optional audio input/output component 305 may also be included to allow a user to use voice for inputting information by converting audio signals. Audio I/O component 305 may allow the user to hear audio. A transceiver or network interface 306 transmits and receives signals between computer system 300 and other devices, such as another user device, a merchant server, or a payment provider server via network 260. In one embodiment, the transmission is wireless, although other transmission mediums and methods may also be suitable. A location determining component 320, such as a GPS system or chip or other devices/systems described herein, communicates with bus 302 to communicate location data that enables a service provider to determine the location of computer system 300. A processor 312, which can be a micro-controller, digital signal processor (DSP), or other processing component, processes these various signals, such as for display on computer system 300 or transmission to other devices via a communication link 318. Processor 312 may also control transmission of information, such as cookies or IP addresses, to other devices.

Components of computer system 300 also include a system memory component 314 (e.g., RAM), a static storage component 316 (e.g., ROM), and/or a disk drive 317. Computer system 300 performs specific operations by processor 312 and other components by executing one or more sequences of instructions contained in system memory component 314. Logic may be encoded in a computer readable medium, which may refer to any medium that participates in providing instructions to processor 312 for execution. Such a medium may take many forms, including but not limited to, non-volatile media, volatile media, and transmission media. In various implementations, non-volatile media includes optical or magnetic disks, volatile media includes dynamic memory, such as system memory component 314, and transmission media includes coaxial cables, copper wire, and fiber optics, including wires that comprise bus 302. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 318 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A computer system for automatically populating dynamic location data in an internet application running in a web browser on a device, comprising:
a non-transitory memory storing instructions; and
one or more hardware processors coupled to the non-transitory memory and configured to read the instructions from the non-transitory memory to cause the system to perform operations comprising:
providing, for display to a user, a user interface for an internet application in a web browser on a device, the internet application allowing the device to participate in an online transaction involving a server machine of another party via the internet;
determining a data field of the internet application for auto-population with an address associated with dynamic location data from the device;
causing, in response to determining the data field of the internet application for auto-population, retrieving the dynamic location data from a Global Positioning System (GPS) of the device;
determining the address associated with the dynamic location data retrieved from the GPS of the device;
causing, based on determining the data field of the internet application for auto-population and based on determining the address associated with the dynamic location data, automatic updating of the user interface of the internet application in the browser by auto-populating the internet application data field with the determined address associated with the dynamic location data; and
providing a version of the address auto-populated in the data field of the internet application to the server machine of the other party via the internet as part of completing the online transaction involving the server machine and the device.

2. The computer system of claim 1, the operations further comprising:
receiving a shipping request for the online transaction between the device and the server machine of the other party.

3. The computer system of claim 1, wherein the determined address associated with the dynamic location data is compared to one or more shipping addresses for the user from one or more previous online transactions with an online payment provider.

4. The computer system of claim 1, the operations further comprising:
receiving a confirmation from the user interface of the internet application indicating user acceptance of the determined address associated with the dynamic location data as an approved shipping address for the online transaction involving the server machine and the device.

5. The computer system of claim 1, the operations further comprising:
receiving a revised version of the determined address associated with the dynamic location data from the user interface of the internet application on the device.

6. The computer system of claim 1, wherein an elevation or height is provided as part of the dynamic location data.

7. The computer system of claim 6, wherein the determined address includes a suite, floor, or apartment number based on the elevation or height associated with the dynamic location data.

8. A computer-implemented method for automatically populating dynamic location data in an internet application running in a web browser on a device, comprising:
providing, for display to a user by one or more processor devices, a user interface for an internet application in a web browser on a device, the internet application allowing the device to participate in an online transaction involving a server machine of another party via the internet;
determining, by one or more of the processor devices, a data field of the internet application for auto-population with an address associated with dynamic location data from the device;
causing, by one or more of the processor devices in response to determining that the internet application data field is to be auto-populated, retrieving of the dynamic location data from a Global Positioning System (GPS) of the device;
determining, by one or more of the processor devices, the address associated with the dynamic location data retrieved from the GPS of device;
causing, by one or more of the processor devices based on determining the data field of the internet application for auto-population and based on determining the address associated with the dynamic location data, automatic updating of the user interface of the internet application in the browser by auto-populating the internet application data field with the determined address associated with the dynamic location data; and
providing, by one or more of the processor devices, a version of the address auto-populated in the data field of the internet application to the server machine of the other party via the internet as part of completing the online transaction involving the server machine and the device.

9. The computer-implemented method of claim 8, further comprising:
receiving a shipping request for the online transaction between the device and the server machine of the other party.

10. The computer-implemented method of claim 8, wherein the determined address associated with the dynamic location data is compared to one or more shipping addresses for the user from one or more previous online transactions with an online payment provider.

11. The computer-implemented method of claim 8, further comprising:
receiving a confirmation from the user interface of the internet application indicating that the determined address associated with the dynamic location data is a selected shipping address for the user.

12. The computer-implemented method of claim 8, further comprising:
receiving a revised version of the determined address associated with the dynamic location data from the user interface of the internet application on the device.

13. The computer-implemented method of claim 8, wherein an elevation or height is provided as part of the dynamic location data.

14. The computer-implemented method of claim 13, wherein the determined address includes a suite, floor, or apartment number based on the elevation or height associated with the dynamic location data.

15. A non-transitory machine-readable medium executable to cause a machine to perform operations to automatically populate dynamic location data in an internet application running in a web browser on a device, the operations comprising:
providing, for display to a user, a user interface for an internet application in a web browser on a device, the internet application allowing the device to participate in an online transaction involving a server machine of another party via the internet;
determining a data field of the internet application for auto-population with an address associated with dynamic location data from the device;
causing, in response to determining the data field of the internet application for auto-population, retrieving the dynamic location data from a Global Positioning System (GPS) of the device;
determining an address associated with the dynamic location data retrieved from the GPS of the device;
causing, based on determining the data field of the internet application for auto-population and based on determining the address associated with the dynamic location data, automatic updating of the user interface of the internet application in the browser by auto-populating the internet application data field with the determined address associated with the dynamic location data; and
a version of the address auto-populated in the data field of the internet application to the server machine of the other party via the internet as part of completing the online transaction involving the server machine and the device.

16. The non-transitory machine-readable medium of claim 15, the operations further comprising:
receiving a shipping request for the online transaction between the device and the server machine of the other party.

17. The non-transitory machine-readable medium of claim 15, wherein the determined address associated with the dynamic location data is compared to one or more shipping addresses for the user from one or more previous online transactions with an online payment provider.

18. The non-transitory machine-readable medium of claim 15, the operations further comprising:
receiving a confirmation from the user interface of the internet application indicating that the determined address associated with the dynamic location data is a desired shipping address for the user.

19. The non-transitory machine-readable medium of claim 15, the operations further comprising:
receiving a revised version of the determined address as a shipping address for the online transaction from the user interface of the internet application on the device.

20. The non-transitory machine-readable medium of claim 15, wherein an elevation or height is provided as part of the dynamic location data.

21. The non-transitory machine-readable medium of claim 20, wherein the suggested shipping address includes a suite, floor, or apartment number based on the elevation or height associated with the dynamic location data associated with the device.
